(19) United States
(12) Patent Application Publication
(10) Pub. No.: US 2024/0192663 A1
(43) Pub. Date: Jun. 13, 2024

(54) Control Device for Computer Device

(71) Applicant: Nippon Telegraph and Telephone Corporation, Tokyo (JP)

(72) Inventors: Kenya Suzuki, Musashino-shi, Tokyo (JP); Ai Yanagihara, Musashino-shi, Tokyo (JP); Keita Yamaguchi, Musashino-shi, Tokyo (JP); Masashi Ota, Musashino-shi, Tokyo (JP); Osamu Moriwaki, Musashino-shi, Tokyo (JP)

(21) Appl. No.: 18/554,398

(22) PCT Filed: May 21, 2021
(86) PCT No.: PCT/JP2021/019453

§ 371 Date: Oct. 6, 2023

(51) Int. Cl. G05B 19/4155; G06F 3/023; G06F 3/0354; G06F 3/038; G06F 3/0487; G06F 40/279; G06T 7/70

(52) U.S. Cl. CPC G05B 19/4155; G06F 3/023; G06F 3/03543; G06F 3/038; G06F 3/0487; G06F 40/279; G06T 7/70; G05B 2219/31368; G06T 2200/24

(57) ABSTRACT

The present disclosure is a control device for automating tasks for control which has been conventionally performed manually for devices including a computer with key input and an user interface (UI), which is difficult to be applied with software such as an RPA that automatically performs tasks in the computer, and the present disclosure is a means for performing automation without analyzing a communication protocol or a control method of a control unit of the computer and a main body of the device, and realizes automation by applying a signal processing technology to a signal of the UI and performing control from an external computer.

### TECHNICAL FIELD

The present disclosure relates to a control device, and more particularly relates to a control device for automating tasks in a computing device included in a manufacturing device, tasks in paperwork, and the like.

### BACKGROUND ART

With the development of information processing technology in recent years, digitization, such as automation of various tasks and automation of manufacturing processes in factories have been in progress. For such automation, software that automatically performs a task in a computer, such as Robotic Process Automation (RPA), is used. Currently, a plurality of RPA software is commercially available, and most of the RPA software is installed in a computer to be controlled and operated in the computer to be controlled, so that an operation performed by a person is automated on the basis of a specified procedure. However, many of these pieces of software have been developed in recent years, and need to be executed by a relatively new computer.

On the other hand, in the manufacturing industry, an expensive manufacturing device cannot be frequently replaced, and manufacturing conditions and manufacturing recipes need to be rederived along with the replacement of the manufacturing device. Therefore, a large amount of operation is required. That is, in manufacturing a certain product, if the product can be smoothly manufactured without problems, motivation for renewal of the manufacturing device is not high.

In addition, such a manufacturing device is often controlled by an old computer. As described above, since software such as RPA needs to be executed by a relatively new computer, it is difficult to apply the latest RPA software to an old computer. Furthermore, since these old computers are not assumed to be connected to a network, it is often difficult to be controlled from an external computer.

FIG. 1 is a diagram conceptually illustrating automation of a conventional general manufacturing device. As illustrated in FIG. 1, the manufacturing device 10 includes a manufacturing device main body 11 that manufactures a product and a computer 12 that controls the manufacturing device main body 11, and the manufacturing device main body 11 and the computer 12 are connected by a control signal line 13 and a measurement signal line 14. A control signal is transmitted from the computer 12 to the manufacturing device main body 11 through the control signal line 13, and a measurement signal is transmitted from the manufacturing device main body 11 to the computer 12 through the measurement signal line 14. Furthermore, the computer 12 can include a processor constituting the control unit 121 that transmits a control signal and receives a measurement signal, a display 122 that displays a user interface (hereinafter, referred to as a UI), a keyboard 123 that transmits key input, and a mouse 124 that performs pointer input. The UI also includes a graphical user interface (hereinafter, referred to as GUI) and a character-based user interface (hereinafter, referred to as CUI). In the manufacturing device 10 having such a configuration, in order to automate a task for controlling the manufacturing device main body 11, the external computer 15 is connected to the control signal line 13 and the measurement signal line 14 in the conventional method. The external computer 15 is installed with software for automating the task for controlling the manufacturing device 10 such as RPA, and includes an automatic control unit 151 that transmits a control signal and receives a measurement signal. Similarly to the existing computer 12, the external computer 15 may include a display 152 that displays a UI, a keyboard 153 that transmits key input, and a mouse 154 that performs pointer input. Then, the control signal and the measurement signal flowing between the control unit 121 and the manufacturing device main body 11 are read, and these signals are processed to automate the task for controlling the manufacturing device main body 11. The processor constituting the control unit 121 may be a general-purpose processor or a dedicated processor. The computer 12 may include a storage device (not illustrated) to which the processor is coupled, and may cooperate with an external storage device (not illustrated). The storage device stores a computer program (instruction) that causes the processor to function as the control unit 121.

These signals may be digital signals or may be analog signals via a digital-to-analog converter. Further, in the conventional automation, the control signal line 13 and the measurement signal line 14 are drawn out and connected to an external computer 15 separately installed. The external computer 15 controls the manufacturing device main body 11 in place of the existing computer 12. In addition, the signal line may be connected to a programmable logic controller or the like incorporated in the existing computer 12.

However, in such a conventional method of processing a signal flowing between the computer 12 and the manufacturing device main body 11, it is necessary to analyze a communication protocol between the control unit 121 and the manufacturing device main body 11 and processing in the control unit 121 to newly develop a control circuit that generates a control signal. In addition, since the manufacturing device 10 itself is old, there are many cases where the automation development of the task is hindered, such as no technical material at the time of device development remains, the person in charge of development is retired, and the device control technical information is proprietary.

### CITATION LIST

### Non Patent Literature

Non Patent Literature 1: H. Haskamp, et al., “Implementing an OPC UA interface For legacy PLC-based automation systems using the Azure cloud: An ICPS-architecture with a retrofitted RFID system”, IEEE ICPS pp. 115-121, 2018.
Non Patent Literature 2: A. Himeno, K. Kato and T. Miya, “Silica-based planar lightwave circuits,” in IEEE Journal of Selected Topics in Quantum Electronics, vol. 4, no. 6, pp. 913-924, November-December 1998, doi: 10.1109/2944.736076.

### SUMMARY OF INVENTION

The present disclosure has been made to solve the above problems. That is, if an operation method is known for a manufacturing device or office device, there is provided a means for automating at least a part of tasks for control which has been conventionally performed manually, without analyzing a communication protocol between a control unit and a device main body or a control method in the device. Furthermore, the present disclosure applies a signal processing technology to a human interface (for example, the GUI) displayed on a display, which can be operated using a keyboard, a mouse, or the like, and controls the human interface from an external computer, thereby automating tasks for control which has been conventionally performed manually.

In order to resolve the above-described problems, according to the present disclosure, there is provided a control device connected to a control unit of a computer as an external device in order to automate at least a part of a task in the computer mounted in a device, in which the device includes a main body and the computer, and the computer includes key input and a GUI, the control device including an image acquisition unit that acquires an image signal of the GUI transmitted from the computer, an image processing unit that processes the image signal acquired by the image acquisition unit, a storage unit that stores a control sequence defining a sequence for controlling the main body of the device, a sequence processing unit that generates a control signal from the image signal processed by the image processing unit and the control sequence stored in the storage unit, and a key signal generation unit that transmits the control signal generated by the sequence processing unit as a key signal, in which processing the image signal includes identifying a keyword in the GUI, and generation of the control signal includes generation of the key signal for controlling the main body of the device based on the keyword identified as the control sequence.

### BRIEF DESCRIPTION OF DRAWINGS

FIG. 1 is a diagram conceptually illustrating automation of a conventional general manufacturing device.

FIG. 2A is a view conceptually illustrating automation of a task for controlling a manufacturing device according to an embodiment of the present invention.

FIG. 2B is a schematic diagram illustrating a two-pole double throw switch mechanism for a key signal and a pointer signal transmitted from an automatic control unit to an existing computer according to an embodiment of the present invention.

FIG. 3 is a block diagram illustrating a configuration of an automatic control unit according to an embodiment of the present invention.

FIG. 4 is a flowchart illustrating a procedure for identifying a position of a mouse pointer according to an embodiment of the present invention.

FIG. 5 is a diagram illustrating a method for identifying a position of a mouse pointer according to an embodiment of the present invention.

FIG. 6 is a flowchart illustrating a procedure for moving a mouse pointer to a desired position.

FIG. 7 is a diagram illustrating a sequence file and an operation thereof according to an embodiment of the present invention.

FIG. 8 is a diagram conceptually illustrating a system for remote controlling an external computer 20 from the outside via a network 81 according to an embodiment of the present invention.

### DESCRIPTION OF EMBODIMENTS

The following is a description of an embodiment of the present invention, with reference to the drawings. A control device for a computer according to an embodiment of the present invention is an external computer installed separately from a computer installed in an existing manufacturing device or office device, and is a device that automates an operation for control in an existing computer that is conventionally performed manually. Then, this external computer is different from the conventional technique on the point that the external computer automatically outputs a control signal for controlling the device main body of the manufacturing device or the office device on the basis of the image signal acquired from the existing computer.

### First Embodiment

Hereinafter, a first embodiment of the present invention will be described. In the present embodiment, for example, task for controlling condition input and the like in an existing computer is automated on a manufacturing device such as a film forming device based on image processing by an external computer.

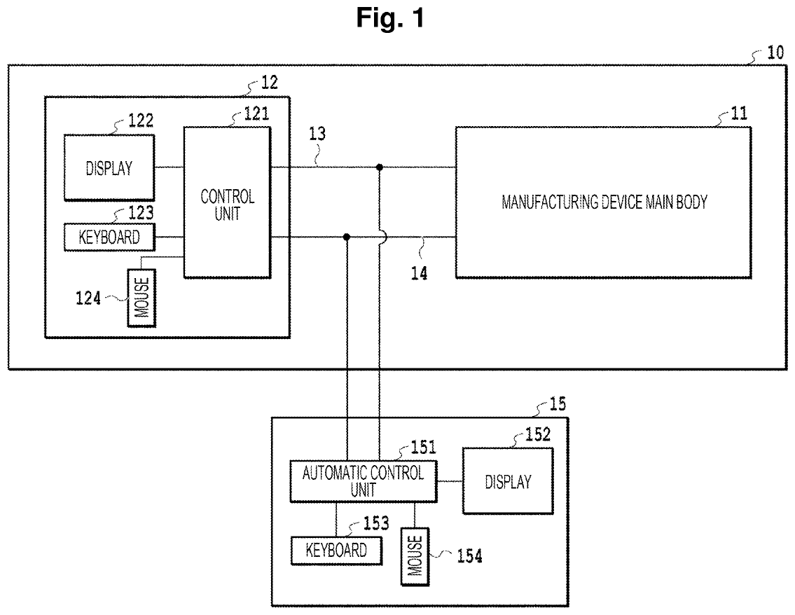

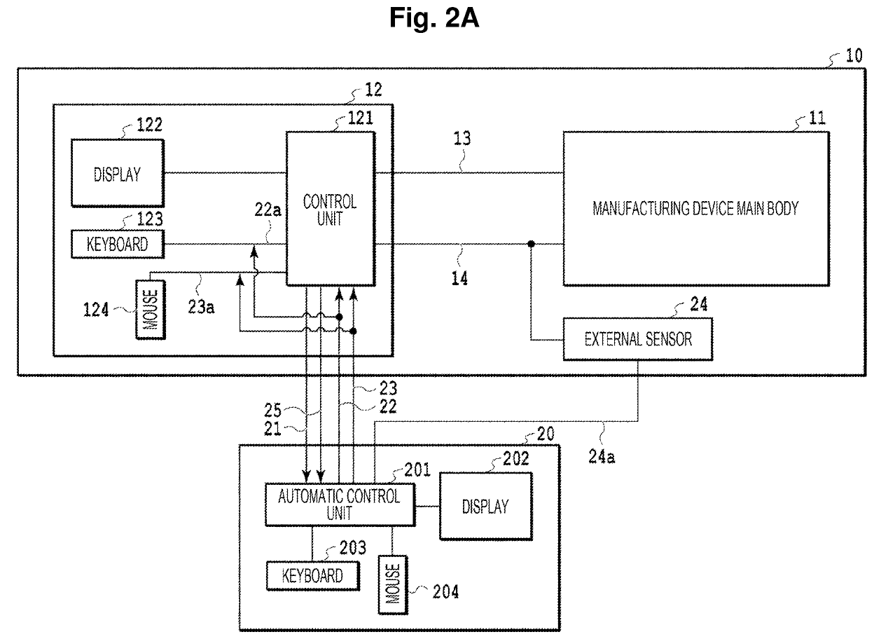

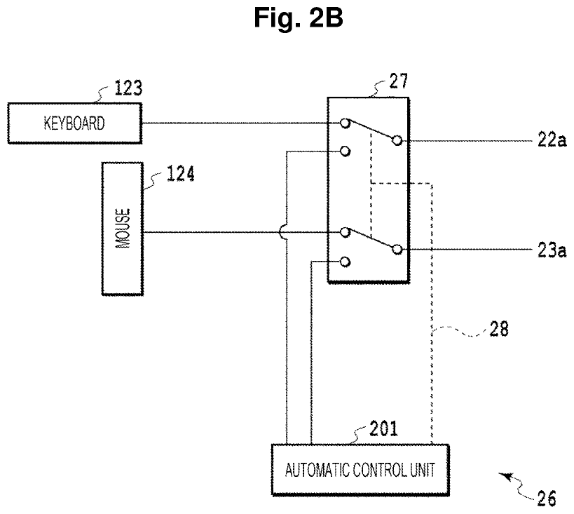

FIG. 2A is a view conceptually illustrating automation of a task for controlling a manufacturing device according to an embodiment of the present invention. In the present embodiment, a manufacturing device 10 includes a manufacturing device main body 11 and a computer 12, and has a conventional configuration as illustrated in FIG. 1. The computer 12 transmits a control signal to the manufacturing device main body 11 via a control signal line 13, and the device main body transmits a measurement signal via a measurement signal line 14. In addition, the computer 12 includes a display 122 that outputs a GUI, a keyboard 123 that transmits key input, and a mouse 124 that transmits pointer input. In the present embodiment, an external computer 20 is connected to a control unit 121 of the computer 12. The external computer 20 includes a processor constituting an automatic control unit 201 that automates tasks for control which has been conventionally performed manually in the existing computer 12. In addition, similarly to the existing computer 12, the external computer 20 may include a display 202 that displays a GUI, a keyboard 203 that transmits key input, and a mouse 204 that performs pointer input. The processor constituting the automatic control unit 201 may be a general-purpose processor or a dedicated processor. The external computer 20 may include a storage device (not illustrated) to which the processor is coupled, and may cooperate with an external storage device (not illustrated). The storage device stores a computer program (instruction) that causes the processor to function as the automatic control unit 201.

In addition, the manufacturing device 10 may include an external sensor 24 that monitors external factors such as temperature and humidity, for example, in the vicinity of the manufacturing device main body 11. The output of the external sensor 24 is connected to the measurement signal line 14, and the external sensor 24 transmits the monitored data of the external factor as the external sensor signal 25. The external sensor signal 25 is transmitted to the automatic control unit 201 via the control unit 121 of the 12. Then, the external sensor signal 25 existing computer transmitted to the automatic control unit 201 is reflected in generation of a control sequence to be described later. Alternatively, the external sensor 24 and the automatic control unit 201 of the external computer 20 may be connected by an external sensor signal line 24a, and the external sensor signal 25 may be directly fetched via the external sensor signal line 24a.

In the control device according to the present embodiment configured as described above, the image signal 21 of the GUI output from the existing computer 12 is acquired, and the acquired image signal 21 is processed in the automatic control unit 201 included in the external computer 20. Next, in the automatic control unit 201, a control signal is generated based on the processed image signal 21 and the control sequence of the manufacturing device main body 11. The generated control signal is transmitted to the control unit 121 in the existing computer 12 as a key signal 22 or a pointer signal 23. By automatically performing this series of operations, it is possible to automate the task for controlling the manufacturing device main body 11 which has been conventionally performed manually. In the present embodiment, the UI displayed by the display 122 is a GUI, however, it may be a CUI.

FIG. 2B is a schematic diagram illustrating a two-pole double throw switch mechanism 26 for a key signal 22 and a pointer signal 23 transmitted from an automatic control unit 201 to an existing computer 12 according to an embodiment of the present invention. In an embodiment of the present invention, the key signal 22 and the pointer signal 23 transmitted from the automatic control unit 201 may be transmitted to the control unit 121 of the existing computer 12 or may be transmitted to a key signal line 22a and a pointer signal line 23a as described later. The switch mechanism 26 is a mechanism for switching the transmission destination, and includes a switch 27 that switches the transmission destination and a switch control line 28 that guides the key signal 22 and the pointer signal 23 transmitted from the automatic control unit 201 to the switch.

The control signal transmitted from the existing computer 12 to the manufacturing device main body 11 is, for example, a pulse signal or the like to the stepping motor of the moving stage built in the manufacturing device 10. Furthermore, in a case where the manufacturing device 10 is an etching apparatus or the like used for semiconductor manufacturing, the control signal is an input signal to the RF signal generator or the like. On the other hand, the measurement signal transmitted from the manufacturing device main body 11 to the computer 12 is read from an encoder of the stage in the former case, and is read by a mass flow controller in the latter case.

In the present embodiment, the computer 12 is a workstation based on a general personal computer Unix (registered trademark), but may be an embedded workstation using a PC98 (registered trademark) series or a compatible machine thereof, a proprietary HP-UX (registered trademark), Solaris (registered trademark), or the like as an operating system. A manufacturer of the manufacturing device 10 may control the manufacturing device 10 by incorporating the same proprietary control software into the computer 12.

On the other hand, the external computer 20 in the present embodiment is a general personal computer or microcomputer, but the latest personal computer or microcomputer in that period may be used.

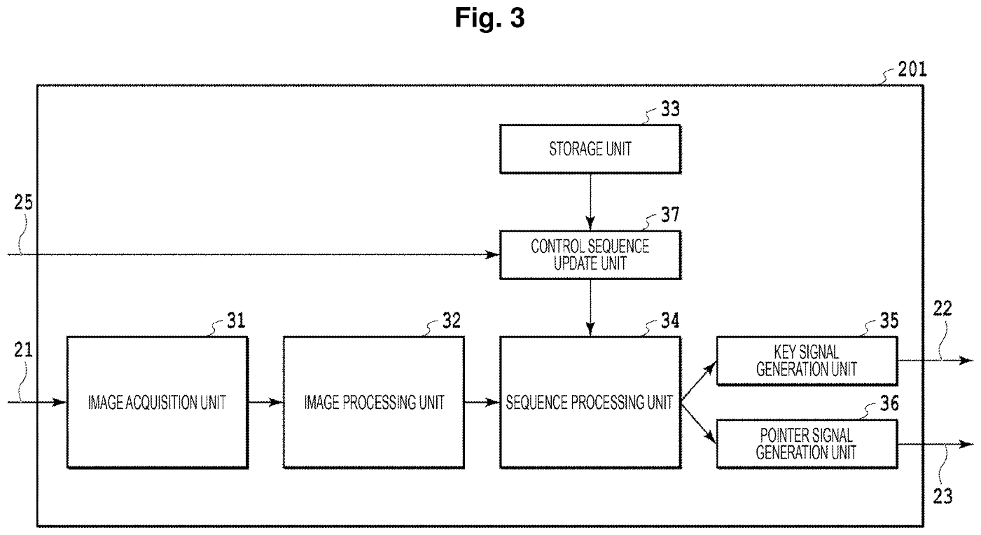

FIG. 3 is a block diagram illustrating a configuration of an automatic control unit 201 according to an embodiment of the present invention. The automatic control unit 201 including an image acquisition unit 31 that acquires an image signal 21 of a GUI from an existing computer 12, an image processing unit 32 that is connected to an output of the image acquisition unit 31 and processes the acquired image signal 21, a storage unit that stores a control sequence that defines a sequence for controlling the main body of the device, a storage unit 33 that stores a control sequence defining a sequence for controlling the manufacturing device main body 11, a sequence processing unit 34 that is connected to respective output of the image processing unit 32 and the storage unit 33 and outputs a control signal from the processed image signal and the control sequence, a key signal generation unit 35 that is connected to an output of the sequence processing unit 34 and transmits the output control signal as a key signal 22 to a control unit 121 in the existing computer 12, and a pointer signal generation unit 36 that is also connected to an output of the sequence processing unit 34 and transmits the output control signal as a pointer signal 23 to the control unit 121 in the existing computer 12. Note that the key signal 22 and the pointer signal 23 may be directly connected to the control unit 121 of the existing computer 12, or may be connected via the key signal line 22a and the pointer signal line 23a. Further, as illustrated in FIG. 2B, the switch mechanism 26 having a two-pole double throw shape may be provided between the keyboard 123, the mouse 124, and the control unit 121 to provide a mechanism for switching signals from the keyboard 123 and the mouse 124 and the key signal 22 and the pointer signal 23 from the automatic control unit 201. In switching, a switching signal may be issued from the automatic control unit 201 via the switch control line 28 connected to the switch.

The image signal 21 acquired by the image acquisition unit 31 is processed by the image processing unit 32, and recognizes the input keyword, the position of the mouse pointer, and the like in the GUI or CUI on the display 122 in the existing computer 12. In addition, the sequence processing unit 34 processes a task to be performed next acquired from the control sequence. For example, the task is like the one in which the mouse pointer is moved onto a button at a specific coordinate on the screen and clicked. Here, the sequence processing unit 34 determines whether the position of the keyword or the mouse pointer processed by the image processing unit 32 is equal to the position of the keyword or the mouse pointer in the image output of the computer 12. If it is determined that they are not equal, the previous sequence is corrected and the determination is repeated again, and if it is determined that they are equal, the process proceeds to the next sequence.

The control sequence stored in the storage unit 33 is a file describing a procedure of tasks in the computer 12 which has been conventionally performed manually, and may be generated by a person or may be generated mechanically. However, since the control sequence is a complicated task that requires setting of a plurality of parameters, manually inputting the control sequence and the parameters to the computer 12 leads to a decrease in throughput in manufacturing. For example, in a glass film forming device in optical device manufacturing, a refractive index, an internal stress, and the like of a glass film fluctuate due to external factors such as environmental temperature and humidity. In order to correct these fluctuations, it is desired to change the manufacturing recipe and parameters of the film forming device each time film formation is performed, but it is not preferable to manually perform the change from the viewpoint of operation and errors at work.

From such a viewpoint, the automatic control unit 201 may include a control sequence update unit 37 that updates the control sequence in order to automate input task of a parameter that is changed by an external factor such as a manufacturing condition and needs to be appropriately updated. The control sequence update unit 37 is a processor connected to an output of the storage unit 33, and has a function of reflecting the above-described external sensor signal 25 on a control sequence stored in advance in the storage unit 33 to automatically generate a new control sequence. The new control sequence generated by the control sequence update unit 37 is transmitted to the sequence processing unit 34 to generate a control signal. Although the control sequence can be automatically generated by the existing computer 12, in this case, it is often difficult to automatically generate the control sequence due to limitations of the performance and function of the computer. Therefore, as illustrated in FIG. 3, it is preferable to generate a control sequence in the automatic control unit 201 in the external computer 20 separately installed.

Hereinafter, as an example of creation of a control sequence, an outline will be described by taking formation of a glass film in manufacturing of an optical device as an example. In manufacturing an optical device called a quartz-based planar lightwave circuit, a flame hydrolysis deposition (FHD) method suitable for forming a thick film glass is used, but film formation on a silicon wafer is performed in a normal pressure gas phase exposed to outside air (e.g., refer to Non Patent Literature 2). Therefore, due to the influence of environmental humidity, water molecules in the air adhere to the soot of the formed glass, and it becomes difficult to obtain a desired glass refractive index. Therefore, it is preferable to monitor the environmental humidity during the deposition of the glass to automatically correct the supply amount of the raw material. More specifically, the refractive index of glass n_{glass} can be assumed to have a linear change in a region where the amount of absorbed moisture is small, and
can be expressed as:
n_{glass}=n₀+α_{OH}×d_{OH}. Here, n₀ and α are constants, and d is the amount of water absorbed into glass. On the other hand, in the FHD method, the refractive index of glass is controlled by controlling the amount of GeO₂ added to SiO₂. Similarly, if the addition amount is denoted by d_{GeO2}, n₀ and d_{GeO2} are used as constants, and
can be expressed as:
n_{glass}=n₀+α_{GeO2}×d_{GeO2}. In addition, if the relationship between the amount of moisture absorbed into the glass d_{OH} when the environmental humidity is how is determined in advance as follows:

d_{OH}=β×d_{OH},
it is possible to control the addition amount of GeO₂ that achieves the target refractive index. Therefore, a desired refractive index is realized by adjusting the supply amount of the source gas of GeO₂ using the control sequence with respect to the environmental humidity that changes from moment to moment.

In order to control the manufacturing device main body 11 by the external computer 20, it is necessary to identify the position of the keyword or the mouse pointer on the image displayed on the display 122 of the computer 12. The keyword identification is realized by using a general OCR function. On the other hand, the identification of the position of the mouse pointer is realized by moving the mouse pointer by a minute amount and analyzing a difference image between two images before and after the movement, as described later.

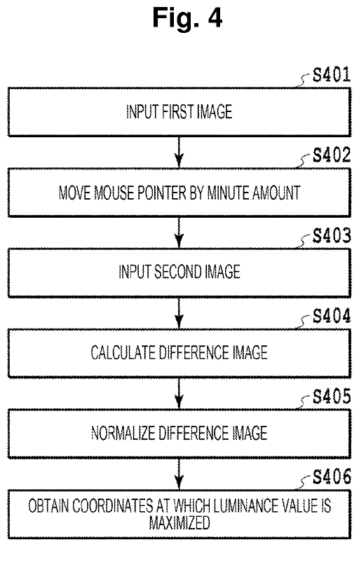

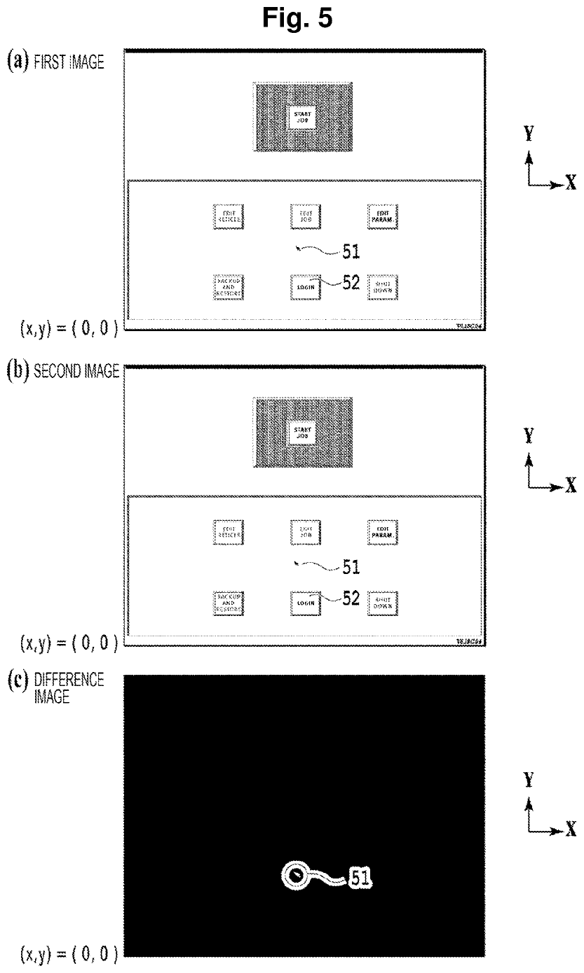

FIG. 4 is a flowchart illustrating a procedure for identifying a position of a mouse pointer according to an embodiment of the present invention, and FIG. 5 is a diagram illustrating a method for identifying a position of a mouse pointer according to an embodiment of the present invention. In the procedure for identifying the position of the mouse pointer 51, first, in step S401, the image processing unit 32 acquires an image in an initial state in which the mouse pointer 51 is stationary (hereinafter, referred to as the first image) as illustrated in FIG. 5 (a) from the image acquisition unit 31. Next, in step S402, the image processing unit 32 moves the mouse pointer 51 by a minute amount as illustrated in FIG. 5 (b), and in step S403, the image processing unit 32 acquires an image after the mouse pointer 51 is moved by the minute amount from the image acquisition unit 31 (hereinafter, referred to as the second image). In step S404, the image processing unit 32 calculates a difference image between the first image and the second image. Note that the difference image is calculated so that the value of each pixel has a positive value by taking the absolute value of each pixel. Normally, the sequence or parameter setting is a still image in many cases, therefore, the difference between the first image and the second image is only the position of the mouse pointer 51 that has been moved. Therefore, in the difference image, only the mouse pointer 51 is emphasized and output as illustrated in FIG. 5(c). Next, in step S405, the image processing unit 32 normalizes the difference image obtained in step S404 by (Formula 1).

u=v×255/(M−m) (Formula 1)

Here, u is a value of each pixel after normalization, M is a luminance value of a pixel having the maximum luminance, m is a luminance value of a pixel having the minimum luminance value, and v is a luminance value of each pixel. Finally, in step S406, the image processing unit 32 identifies coordinates at which the luminance value obtained by (Formula 1) is maximized as the position of the mouse pointer 51, and outputs the identified position of the mouse pointer 51.

In the above-described minute amount movement of the mouse pointer 51, it is preferable to move in both the positive direction and the negative direction of the X component of the screen or in both the positive direction and the negative direction of the Y component. This is because, when the mouse pointer 51 is at the screen end, the mouse pointer does not move in the direction of moving to the outside of the screen.

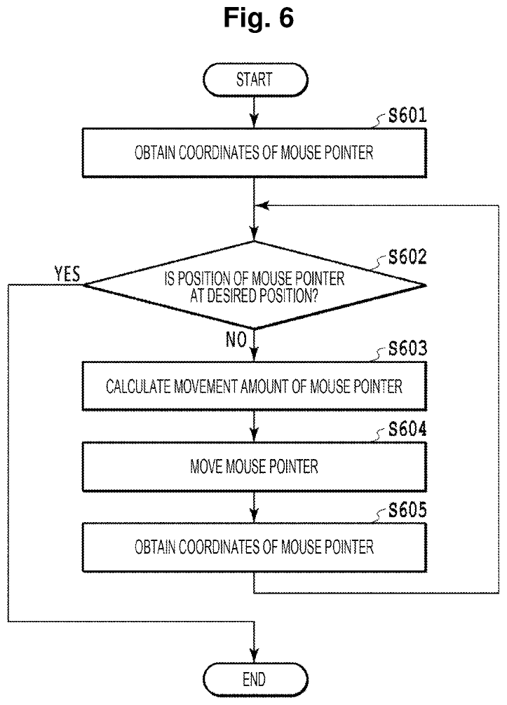

FIG. 6 is a flowchart illustrating a procedure for moving a mouse pointer to a desired position. In order to move the mouse pointer to a desired position, first, in step S601, the position of the mouse pointer is obtained according to the method described above with reference to FIGS. 4 and 5. Next, in step S602, the sequence processing unit 34 compares the position obtained with the position of the pointer to be moved designated in the control sequence and determines whether the pointer is present in the positional deviation range allowed from the target position. As a result of the determination, in a case where the pointer exists within the allowable positional deviation range (Yes in S602), the processing ends. On the other hand, when the pointer does not exist within the allowable positional deviation range (No in S602), the sequence processing unit 34 calculates a difference between the target position and the current pointer position in step S603. In step S604, the pointer signal generation unit 36 generates the pointer signal 23 for moving the pointer based on the calculated difference. In step S605, the sequence processing unit 34 acquires the pointer position after the pointer is moved in response to the pointer signal 23 from the image processing unit 32, and performs the above-described determination. According to such a procedure, the mouse pointer is moved to a desired position.

In this way, the loop of moving and determining the pointer position is repeated for the following reasons. In general, a mouse pointer as a human interface moves with an acceleration with respect to a movement amount of a mouse. That is, when a person moves a mouse, a mouse pointer also moves by a minute amount in the case of a minute movement, but in the case of a large movement, the pointer moves with acceleration more than the movement pulse amount the mouse actually counts. This acceleration is individually set for each conventional control unit that is a controlled object, and thus cannot be commonly applied to all controlled objects. Therefore, it is preferable to repeat the loop as described above.

In addition, the above-described allowable positional deviation range is preferably a range that falls within the size of the button 52 of the control software provided by the manufacturer of the device. For example, the allowable positional deviation is desirably within the size range of the button 52 described as “LOGIN” in FIG. 5 (a).

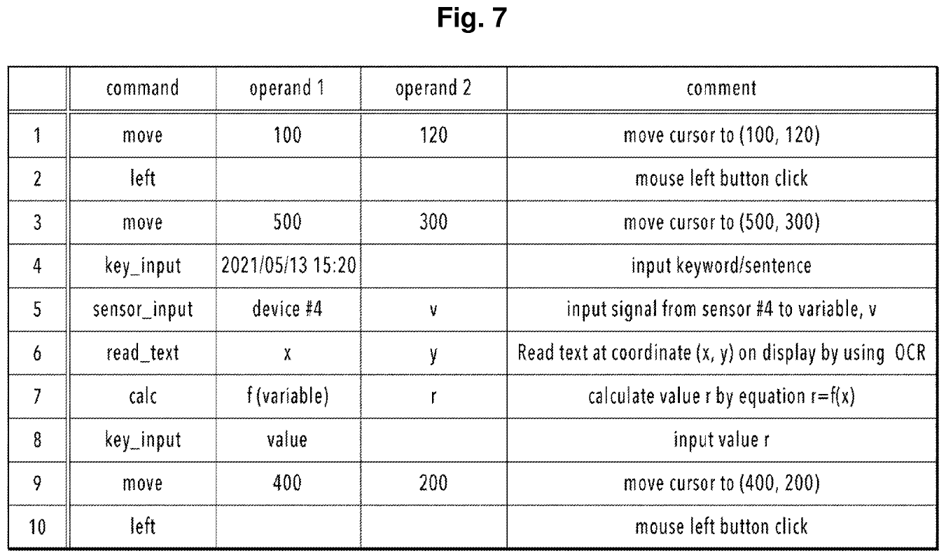

FIG. 7 is a diagram illustrating a control sequence and its operation according to an embodiment of the present invention. In the control sequence illustrated in FIG. 7 as an example, the following operation is given in each row.
1 Move the mouse cursor to coordinates (100, 120) on the screen
2 Click the left mouse button
3 Move the mouse cursor to coordinates (500, 300) on the screen
4 Input characters and a sentence “2021/05/13 15:20”
5 Read a value from the sensor device #4 and input the value into the variable v (the sensor device may be a temperature sensor, a humidity sensor, or the like, depending upon the device to be controlled)
6 Read a character string of coordinates (x, y) on the screen. For example, read a value, a setting value, or the like of a sensor monitored by the manufacturing device itself. Character recognition such as optical character recognition (OCR) is used.
7 r=f (v) is calculated using the function ƒ (x) in which the variable v is set in advance
8 Input r as a character
9 Move the mouse cursor to coordinates (400, 200) on the screen
10 Click the left mouse button

By setting such a control sequence in advance, it is possible to automate tasks for controlling the manufacturing device 10 having a legacy computer that cannot directly use the RPA. In addition, it is also possible to automatically generate an appropriate recipe according to a situation such as an environmental change by utilizing input from an external sensor. According to the example of the glass film formation described above, the sensor device #4 is a humidity sensor, and the character string on the screen (x, y) is a reading of the mass flow controller and represents the current supply amount of GeO₂. Furthermore, the variable r is a setting value of the new mass flow controller, and is calculated using f (v) expressed by the above-described three formulas. The movement and clicking of the mouse cursor corresponding to the procedures 9 and 10 described in FIG. 7 are operations of determining the set value r and inputting the value r to the device.

As described above, in the control device according to the present embodiment, the automatic control unit 201 of the external computer 20 processes the image signal from the computer 12 and transmits the control signal based on the image signal. Therefore, it is possible to automate the control of the manufacturing device main body 11 without analyzing the communication protocol and the control method between the computer 12 and the manufacturing device main body 11 as in the conventional technique.

Furthermore, in the present embodiment, since the control sequence is automatically generated in the automatic control unit 201, it is possible to automatically set the control recipe and parameters of the manufacturing device main body 11, which have been conventionally performed manually. Therefore, it is possible to improve the manufacturing throughput and the product yield as compared with the conventional technique.

### Second Embodiment

Hereinafter, a second embodiment of the present invention will be described. In the present embodiment, unlike the first embodiment, an external computer 20 is configured to perform remote control from an external terminal via a network.

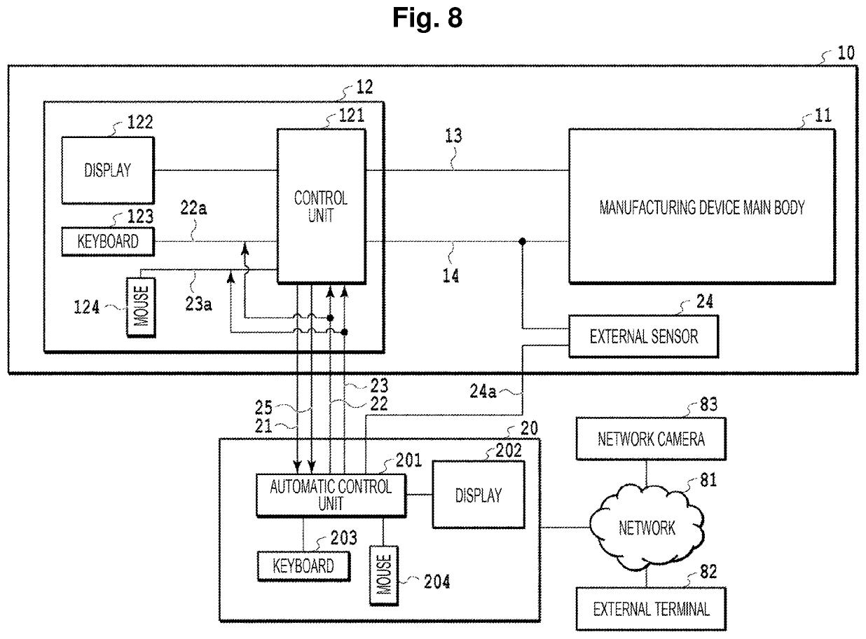

FIG. 8 is a diagram conceptually illustrating a system for remote controlling the external computer 20 from the outside via a network 81 according to an embodiment of the present invention. Similarly to the first embodiment, in the present embodiment, a manufacturing device main body 11 and a computer 12 have a conventional configuration, and the computer 12 transmits a control signal to the manufacturing device main body 11 via a control signal line 13, and the device main body transmits a measurement signal via a measurement signal line 14. In addition, as illustrated in FIGS. 2 and 3, the external computer 20 has the same configuration as that of the first embodiment.

In addition to the above configuration, the present embodiment has a configuration in which the external computer 20 is connected to an external terminal 82 via the network 81. As the network 81, for example, a communication technology such as Ethernet (registered trademark), Worldwide Interoperability For Microwave Access (WiMAX (trademark)), 3G, 4G, or Digital Subscriber Line (DSL) can be used. Furthermore, the external terminal 82 may be a thin client or a fat client. In addition, in a case where the RPA software is installed in the fat client itself, the external computer 20 may be controlled therefrom.

Furthermore, a network camera 83 may be installed in the vicinity of the manufacturing device main body 11, and the network camera 83 may also be connected to the external terminal 82 via the network 81. As a result, the user who performs remote control can monitor the state of the manufacturing device main body 11 controlled.

The control device according to the present embodiment configured as described above can automate the task for controlling the manufacturing device main body 11 similarly to the first embodiment by the user remotely operating the external computer 20 via the external terminal 82. Therefore, it is possible to achieve the same effects as those of the first embodiment even remotely. The place where the external terminal 82 is located may be a room other than the room where the manufacturing device 10 is located, or may be a house other than the factory where the manufacturing device 10 is installed. In a case where the manufacturing device 10 is installed in an isolated place such as a clean room, for example, it takes time and effort to go in and out. However, according to the present embodiment, for example, remote control such as control monitoring in an office or control monitoring at the time of working at home can be performed.

As described above, the present disclosure can be applied to a computer having at least one of key input and pointer input and image output in order to automate the task. Furthermore, the present invention can also be applied to control of an old computer in which RPA software does not operate. That is, the present invention can be applied not only to automate manufacturing devices but also to automate normal paperwork and general operations.

### INDUSTRIAL APPLICABILITY

Application as a control device for automating operations in a manufacturing device or an office device is expected.

1. A control device connected to a control unit of a computer as an external device in order to automate at least a part of a task in the computer mounted in a device, in which the device includes a main body and the computer, and the computer includes key input and a user interface (UI), the control device comprising:
an acquisition unit that acquires a signal of the UI transmitted from the computer;
a processing unit that processes the signal of the UI acquired by the acquisition unit;
a storage unit that stores a control sequence defining a sequence for controlling the main body of the device;
a sequence processing unit that generates a control signal from the signal of the UI processed by the processing unit and the control sequence stored in the storage unit; and
a key signal generation unit that transmits the control signal generated by the sequence processing unit as a key signal,
wherein processing the signal of the UI includes identifying a keyword in the UI, and
generation of the control signal includes generation of the key signal for controlling the main body of the device based on the keyword identified as the control sequence.

2. The control device according to claim 1, wherein
the computer further includes pointer input,
the UI includes a graphical user interface (GUI), acquisition of the signals of the UI includes acquiring image signals of the GUI, and processing of the signals of the UI includes processing the image signals of the GUI,
the control device further includes a pointer signal generation unit that transmits the control signal generated by the sequence processing unit as a pointer signal,
the processing of the image signal further includes identifying a position of a mouse pointer in the GUI,
generation of the control signal further includes generating the pointer signal for controlling the main body of the device based on a position of the mouse pointer identified as the control sequence, and
identification of the position of the mouse pointer includes calculating a difference image from images before and after a minute amount of movement of the mouse pointer in the GUI.

3. The control device according to claim 2, wherein the key signal and the pointer signal are generated when a position of the identified mouse pointer is at a desired position by repeating a minute amount of movement of the mouse pointer and calculation of the difference image.

4. The control device according to claim 1, further comprising a control sequence update unit that changes the control sequence stored in the storage unit based on data of an external factor monitored by an external sensor in the vicinity of the main body of the device.

5. The control device according to claim 1, wherein the control device is configured to be controlled from an external terminal via a network.

6. The control device according to claim 2, further comprising a control sequence update unit that changes the control sequence stored in the storage unit based on data of an external factor monitored by an external sensor in the vicinity of the main body of the device.

7. The control device according to claim 3, further comprising a control sequence update unit that changes the control sequence stored in the storage unit based on data of an external factor monitored by an external sensor in the vicinity of the main body of the device.

8. The control device according to claim 2, wherein the control device is configured to be controlled from an external terminal via a network.

9. The control device according to claim 3, wherein the control device is configured to be controlled from an external terminal via a network.

10. The control device according to claim 4, wherein the control device is configured to be controlled from an external terminal via a network.
